(19) United States
(12) Patent Application Publication
(10) Pub. No.: US 2024/0394057 A1
(43) Pub. Date: Nov. 28, 2024

(54) RISC-V VECTOR EXTENTION CORE, PROCESSOR, AND SYSTEM ON CHIP

(71) Applicant: Alibaba Innovation Private Limited, Singapore (SG)

(72) Inventors: Qichen ZHANG, Shanghai (CN); Zhe ZHANG, Beijing (CN); Linyong HUANG, Shanghai (CN); Hongzhong ZHENG, Los Gatos, CA (US)

(21) Appl. No.: 18/667,528

(22) Filed: May 17, 2024

(30) Foreign Application Priority Data
May 22, 2023 (CN) 202310577917.7

(51) Int. Cl. G06F 9/30; G06F 9/38

(52) U.S. Cl. CPC G06F 9/30036; G06F 9/3856

(57) ABSTRACT

A reduced instruction set computer (RISC)-V vector extension (RVV) core communicated with one or more accelerators. The RVV core includes: a command queue configured to output commands; and an interface unit communicatively coupled to the command queue and having circuitry configured to generate an accelerator command to an accelerator of the one or more accelerators based on the output commands.

### CROSS-REFERENCE TO RELATED APPLICATIONS

The disclosure claims the benefits of priority to Chinese Application No. 202310577917.7, filed May 22, 2023, which is incorporated herein by reference in its entirety.

### TECHNICAL FIELD

The present disclosure generally relates to computer technologies, and more particularly, to a RISC (Reduced Instruction Set Computer)-V Vector extension (RVV) core, a processor, and a system on chip (SoC).

### BACKGROUND

A RISC (Reduced Instruction Set Computer)-V Vector extension (RVV) is a RISC-V instruction set-based architecture added with new instructions to satisfy a requirement of a specific application. The RVV provides a vector computing capability for a RISC-V processor, and is widely used in high-performance products. Due to desirable extendibility, the RVV is usually used in combination with an accelerator.

Therefore, implementation of communication between the accelerator and the RVV is a challenge for improving the performance.

### SUMMARY OF THE DISCLOSURE

Embodiments of the present disclosure provide a reduced instruction set computer (RISC)-V vector extension (RVV) core communicated with one or more accelerators. The RVV core includes: a command queue configured to output commands; and an interface unit communicatively coupled to the command queue and having circuitry configured to generate an accelerator command to an accelerator of the one or more accelerators based on the output commands.

Embodiments of the present disclosure provide a processor including a scalar core configured to perform process operations; and a reduced instruction set computer (RISC)-V vector extension (RVV) core communicated with one or more accelerators. The RVV core includes: a command queue configured to output commands; and an interface unit communicatively coupled to the command queue and having circuitry configured to generate an accelerator command to an accelerator of the one or more accelerators based on the output commands.

Embodiments of the present disclosure provide a system on chip comprising a processor and one or more accelerators. The processor includes a scalar core configured to perform process operations; and a reduced instruction set computer (RISC)-V vector extension (RVV) core communicated with one or more accelerators. The RVV core includes: a command queue configured to output commands; and an interface unit communicatively coupled to the command queue and having circuitry configured to generate an accelerator command to an accelerator of the one or more accelerators based on the output commands.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic block diagram of an exemplary processing system, according to some embodiments of the present disclosure.

FIG. 2A is a schematic diagram of communication between an accelerator and a RVV in the related art.

FIG. 2B is another schematic diagram of communication between an accelerator and a RVV in the related art.

FIG. 3 is a schematic diagram of communication between an accelerator and a RVV core, according to some embodiments of the present disclosure.

FIG. 4 is a schematic diagram of an exemplary interface unit of a RVV core, according to some embodiments of the present disclosure.

FIG. 5 is a structural block diagram of an exemplary processor, according to some embodiments of the present disclosure.

FIG. 6 is a schematic structural diagram of an exemplary system on chip, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Specific implementations of the embodiments of the present disclosure are further described below with reference to the drawings.

RISC-V is an open-source instruction set architecture (ISA) based on the principle of a reduced instruction set computer (RISC).

Compared to most instruction sets, an RISC-V instruction set may be freely used for any purpose, and allow anyone to design, manufacture, and sell RISC-V chips and software. Although the RISC-V instruction set is not the first open-source instruction set, it is of great significance because its design adapts to modern computing devices (such as warehouse-scale cloud computers, high-end mobile phones, and micro embedded systems). Designers considered performance and power efficiency in these applications. The instruction set is supported by numerous software, which resolves a common weakness of new instruction sets. The RISC-V architecture is a free, simple, and extendable ISA. Billions of RISC-V processors are produced each year.

A RVV architecture is a RISC-V instruction set-based architecture added with new instructions to satisfy a requirement of a specific application. The RVV provides a vector computing capability for a RISC-V processor, and is widely used in high-performance products.

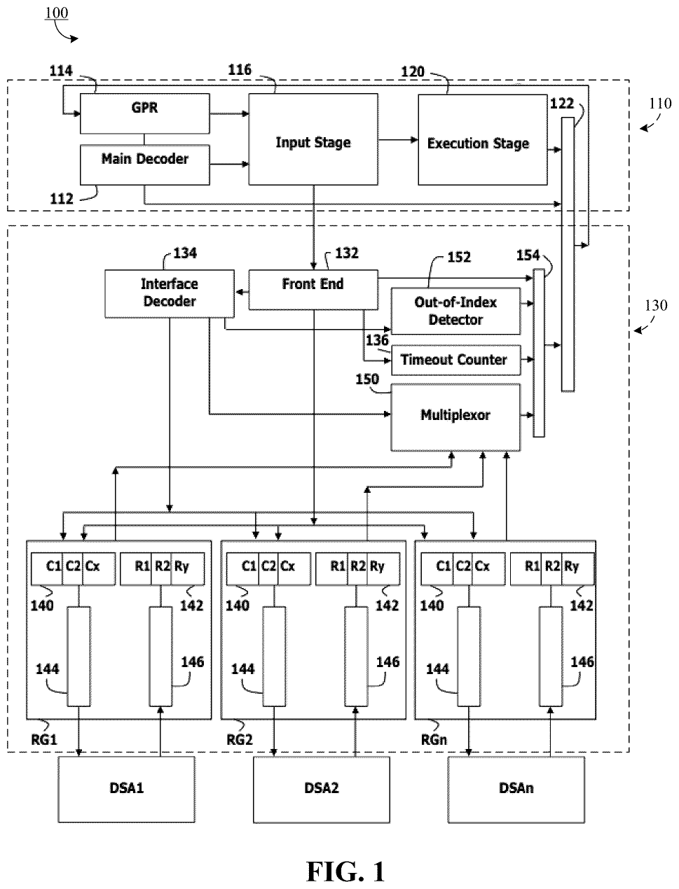

FIG. 1 is a schematic block diagram of an exemplary processing system architecture 100, according to some embodiments of the present disclosure. As shown in FIG. 1, a processing system architecture 100 includes a main processor 110. The main processor 110 includes a main decoder 112, a multiword general-purpose register (GPR) 114 connected to the main decoder 112, and an input stage 116 connected to the main decoder 112 and the GPR 114. In addition, the main processor 110 includes an execution stage 120 connected to the input stage 116, and a switch 122 connected to the main decoder 112, the execution stage 120, and the GPR 114.

The main decoder 112, the GPR 114, the input stage 116, and the execution stage 120 are common elements in main processors, and can be used in a RISC-V processor. For example, a GPR in a RISC-V processor has 32 memory units, and each memory unit has a length of 32 bits. In addition, the execution stage 120 usually includes an arithmetic logical unit (ALU), a multiplier, and a load store unit (LSU).

As further shown in FIG. 1, the processing system 100 further includes an interface unit 130 connected to the input stage 116 and the switch 122 of the main processor 110. The interface unit 130 includes a front end 132 connected to the input stage 116, an interface decoder 134 connected to the front end 132, and a timeout counter 136 connected to the front end 132.

The interface unit 130 further includes a plurality of interface registers RG1-RGn, and each interface register RG is connected to the front end 132 and the interface decoder 134. Each interface register RG has a command register 140 and a response register 142. The command register 140 has a plurality of 32-bit command storage units C1-Cx, and the response register 142 has a plurality of 32-bit response storage units R1-Ry.

Although in this example, each command registers 140 shown in FIG. 1 has the same quantity of command storage units C, alternately the command registers 140 may have different quantities of command storage units C. Similarly, each response registers 142 shown in FIG. 1 has the same quantity of response storage units R in this example, alternately the response registers 142 may have different quantities of response storage units R.

In addition, each of the interface registers RG has a first-in first-out (FIFO) output queue 144 connected to the command register 140 and a FIFO input queue 146 connected to the response register 142. Each row of the FIFO output queue 144 has the same number of storage units as the storage units in the command register 140. Similarly, each row of the FIFO input queue 146 has the same quantity of storage units as the storage units in the response register 142.

In addition, the interface unit 130 further includes an output multiplexer 150 connected to the interface decoder 134 and each interface register RG. In some embodiments, the interface unit 130 may include an out-of-index detector 152 connected to the interface decoder 134. In addition, the interface unit 130 further includes a switch 154 connected to the front end 132. The switch 154 selectively connects the timeout counter 136, the multiplexer 150, or the out-of-index detector 152 (when used) to the switch 122.

Still referring to FIG. 1, the processing system architecture 100 further includes a plurality of domain specific architectures (DSAs) DSA1-DSAn connected to the output queues 144 and the input queues 146 of the interface registers RG1-RGn. The DSAs may be implemented by using various conventional accelerators, such as accelerators for videos, vision, artificial intelligence, vectors, and general matrix multiplication. In addition, the DSAs may run at any desired clock frequency.

As described in more details below, many new instructions, including an accelerator write instruction, a push ready instruction, a push instruction, a read ready instruction, a pop instruction, and a read instruction, can be added to a conventional ISA. For example, RISC-V has four basic instruction sets (RV32I, RV32E, RV64I, and RV128I) and some extended instruction sets (for example, M, A, F, D, G, Q, C, L, B, J, T, P, V, N, and H) that may be added to the basic instruction sets to achieve a specific goal. In this example, the RISC-V is modified in such a way that the new instructions are included in a custom extended set.

In addition, the new instructions use the same instruction format as another instruction in the ISA. For example, the RISC-V has six instruction formats. One of the six formats is an I-type format, which has a 7-bit operation code field, a 5-bit target field that identifies a target unit in a GPR, a 3-bit function field that identifies an operation, a 5-bit operand field that identifies a position of an operand in a GPR, and a 12-bit immediate field.

There are two types of accelerators connected to the RVV: a tightly coupled accelerator and a loosely coupled accelerator. The tightly coupled accelerator uses a custom RVV, and operates as a computing unit in a RVV core. The loosely coupled accelerator is connected to a RVV core through a memory-mapped I/O (MMIO).

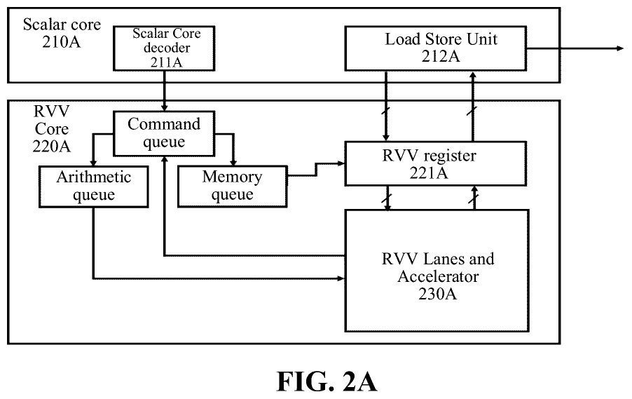

FIG. 2A is a schematic diagram of communication between a tightly coupled accelerator and a RVV in the related art. Referring to FIG. 2A, a tightly coupled accelerator 230A is located inside a RVV core 220A, and shares a RVV register 221A and a scalar core decoder 211A and a load store unit 212A of a scalar core 210A. To share the scalar core decoder 211A, accelerators 230A need to use a custom 32-bit ISA, which is too short for specific accelerators. In addition, some accelerators have complex computing units. It is very difficult to merge the accelerators 230A into a data path of the RVV core 220A. It is difficult for the RVV core 220A to collaborate with different hardware designs in the accelerators 230A.

FIG. 2B is another schematic diagram of communication between a loosely coupled accelerator and a RVV in the related art. Referring to FIG. 2B, a loosely coupled accelerator 230B is connected to a RVV core 220B through an MMIO or in another temporary communication manner. The loosely coupled accelerator 230B has an accelerator decoder 231B, an accelerator load store unit 232B, and an accelerator register 233B. A scalar core 210B forwards data between the accelerator 230B and RVV core 220B. However, loosely coupled accelerators have a large delay, and cannot readily use a RISC-V software toolchain.

It may be learned from the above that, tightly coupled accelerators need to perform extensive hardware tasks and therefore are not sufficiently flexible, while loosely coupled accelerators need to perform extensive software tasks, and therefore have a relatively high delay, and have indirect connection with the RVV core.

Due to absence of direct connection between the RVV and the accelerator, the RVV and the accelerator cannot collaborate efficiently.

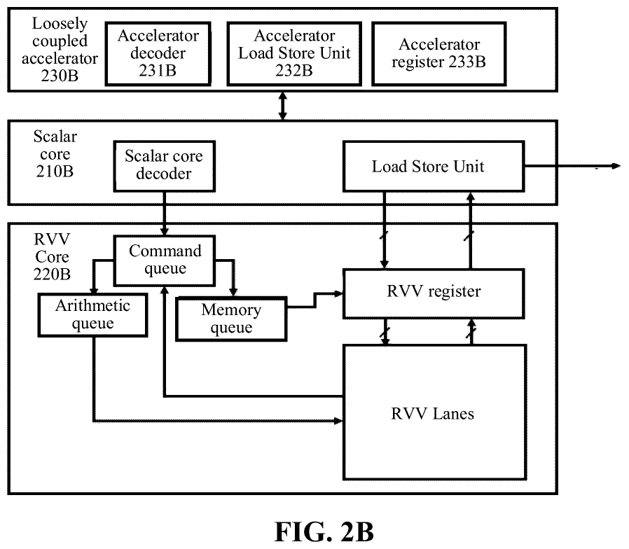

In order to overcome the above defect, the embodiments of the present disclosure provide a RVV core that can directly communicate with an accelerator. FIG. 3 is an exemplary schematic diagram of communication between an accelerator and a RVV core, according to some embodiments of the present disclosure. Referring to FIG. 3, a processor 300 includes a scalar core 310 and a RVV core 320. The scalar core 310 acts as the main control processor to perform process operations, and all the instructions are fetched and decoded in the scalar pipeline. The RVV core 320 includes a RVV register 325. The RVV register 325 is configured to store data for the RVV core 320. The RVV core 320 further includes a command queue 322 and an interface unit 321. The command queue 322 may output commands to be pushed to an accelerator 330 through the interface unit 321. The interface unit 321 includes circuitry configured to generate an accelerator command 341 to the accelerator 330. The command from the command queue 322 has a format compatible with the ISA of the RVV core, and the accelerator command 341 generated by the interface unit 321 is compatible with the ISA of the accelerator 330. Therefore, the accelerator 330 is directly connected to the RVV core 320 through the interface unit 321. The interface unit 321 receives commands to be pushed to the accelerator 330 from the command queue 322, and is configured to generate accelerator commands 341 based on the ISA of the accelerator 330 and the commands received from the command queue 322. More specifically, the accelerator 330 includes an accelerator decoder 331, and the accelerator command 341 is generated based on the ISA of the accelerator 330 and pushed to the accelerator decoder 331. For example, if the RVV core 320 is a 32-bit ISA, and the accelerator 330 is a 128-bit ISA, the interface unit 321 is configured to generate a 128-bit command for the accelerator 330 based on four 32-bit commands of the RVV core 320. Therefore, the ISA of the accelerator 330 does not need to be compatible with the RISC-V, and the accelerator 330 and RVV core 320 can use the RISC-V software toolchain in an easy way.

In some embodiments, the interface unit 321 is a queue-based FIFO module. That is, the commands received from the command queue 322 follow the FIFO rule. In some embodiments, the command queue 322 also outputs an arithmetic queue 323 to RVV lanes 326 and a memory queue 324 to the RVV register 325, which is the same as that in the related art, and therefore is not described in detail herein.

In some embodiments, the RVV register 325 is shared by the RVV core 320 and the accelerator 330, that is, the RVV register 325 is also accessible by the accelerator 330 and is further configured to store data for the accelerator 330. More specifically, the accelerator 330 further includes an accelerator load store unit 332 includes circuitry configured to perform read and write operations 342 on the RVV register 325. In some embodiments, the read/write operation 342 can be completed very quickly, for example, within 10 cycles in-and-out according to the clock frequency. Since the RVV register 325 is shared by the RVV core 320 and the accelerator 330, communication between the RVV core 320 and the accelerator 330 has a lower delay and higher performance, and the constructed system on chip has higher efficiency with a same area.

In the solutions of the embodiments of the present disclosure, the accelerator 330 is directly connected to the RVV core 320 through the interface unit 321, and the interface unit 321 enables the command queue 322 of the RVV core 320 to be pushed to the accelerator decoder 331 of the accelerator 330 compatible with the ISA of the accelerator 330. Therefore, the ISA of the accelerator 330 does not need to be compatible with the RISC-V, and the command queue 322 can be reconstructed in the interface unit 321 to generate an accelerator command 341 and pushed to the accelerator decoder 331 of the accelerator 330. In another aspect, the RVV register 325 is shared by the RVV core 320 and the accelerator 330, communication between the RVV core 320 and the accelerator 330 has a lower delay and higher performance, and the constructed system on chip has higher efficiency with a same area.

In some embodiments, the accelerator 330 is a custom accelerator. When a RISC-V processor, for example, processor 300, functions as a controller, the RISC-V processor needs to be equipped with a powerful custom accelerator. The custom accelerator 330 has performance exceeding that of the RVV. Therefore, with the above configuration, a delay of communication between the RVV core 320 and the accelerator 330 can be reduced, and higher performance is obtained.

In some embodiments, the read/write operation 342 is performed based on a number of bits (VLEN bits, i.e., a maximum length of a vector register) in a single vector register. In some embodiments, the speed of the read/write operation 342 can be further increased, and accuracy of the read/write operation 342 can be ensured.

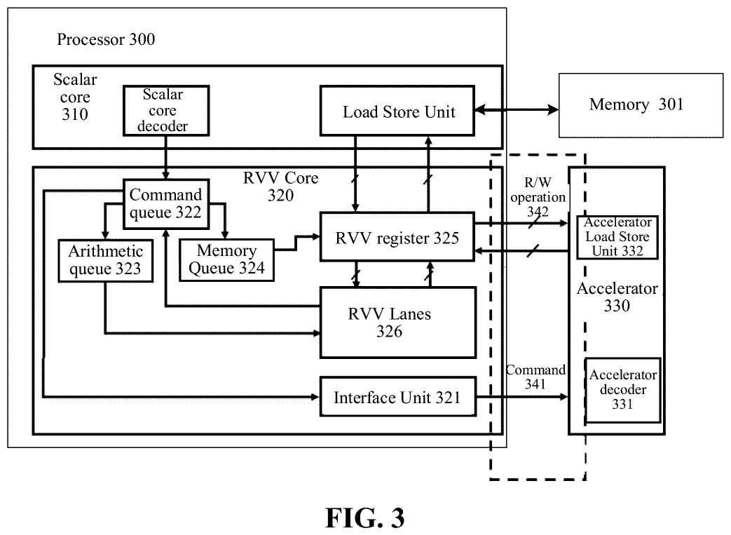

In some embodiments, one or more accelerators can be communicated with the RVV core 320, which will be described below with reference to FIG. 4.

FIG. 4 is a schematic diagram of an exemplary interface unit 321 of a RVV core shown in FIG. 3, according to some embodiments of the present disclosure. Referring to FIG. 3 and FIG. 4, the interface unit 321 is a queue-based FIFO module. In some embodiments, the interface unit 321 is an XoCC, which is a driver that includes XOCFE, AST2IR (abstract syntax tree to instruction register), XOC and XGEN into complete C compiler. The XOCFE is a C frontend which outputs abstract syntax tree (AST). The XOC provides multi-level IRs, flexibility, and the capability of representing almost all popular languages. The XGEN provides a retargetable machine code generator. In some embodiments, the interface unit 321 includes a RVV front end 3211 (corresponding to the front end 132 in FIG. 1), one or more channels 3212, and command registers 3213 (corresponding to the command register 140 in FIG. 1) and response registers 3214 (corresponding to the response register 142 in FIG. 1) corresponding to the one or more channels 3212. The RVV front end 3211 is configured to decode received function signals and send control signals to perform instructions (e.g., clock configuration, reset instructions, and etc.) for the one or more channels 3212. The response register 3214 is configured to receive instruction set architecture (ISA) of each of the one or more accelerators respectively. The command register 3213 is configured to generate the accelerator command 341 based on the ISA of a corresponding accelerator and the command queue. Custom instructions are executed to push, based on FIFO, the command queue 322 of the RVV core 320 and generate the accelerator command 341 to the decoder 331 of the accelerator 330 by the command registers 3213 and the response registers 3214.

The interface unit 321 further includes an interface 3215 configured to communicate with the one or more accelerators. Specifically, the one or more channels 3212 are configured to provide one or more communication channels to respectively exchange data with respective connected accelerators through the interface 3215 based on clocks CLK1, CLK2, CLK3, . . . , CLKn provided by the RVV front end 3211. In some embodiments, the interface 3215 is a standard FIFO interface.

In some embodiments, the custom instructions for the accelerators are added. Therefore, the accelerator 330 and the RVV core 320 can use the RISC-V software toolchain simply. Designers tend to integrate a custom instruction set into a standard RVV as an accelerator. In a conventional method, all instructions (regardless of control instructions or computing instructions) of the accelerator are customized into the RVV. In some embodiments, the custom instructions can be stored in a memory 301 communicatively coupled to the scalar core 310, and the scalar core 310 can fetch the custom instructions from the memory 301. When the custom instructions are executed, accelerator commands 341 are generated and pushed to the accelerator 330.

Specifically, the custom instructions may include: a first command (PUSH_CMD), a second command (POP_RSP), a third command (WRITE_CMD), a fourth command (READ_RSP), a fifth command (PUSH_RDY), and a sixth command (POP_RDY). The first command (PUSH_CMD) is configured to push content of a command register corresponding to a selected channel of the one or more channels into the accelerator command queue. The second command (POP_RSP) is configured to pop out content from a response queue and place the content into a response register corresponding to the selected channel of the one or more channels. The third command (WRITE_CMD) is configured to write content obtained from the command queue of the RVV core into a specified unit of the command register corresponding to the selected channel of the one or more channels. The fourth command (READ_RSP) is configured to read content from a specified unit of the response register corresponding to the selected channel of the one or more channels. The fifth command (PUSH_RDY) is configured to obtain a full signal state of the command queue. The sixth command (POP_RDY) is configured to obtain an empty signal state of the response queue.

In some embodiments, the custom instructions only include the six commands. Since only the simple custom instructions of the interface are added, the accelerator and the RVV core can use the RISC-V software toolchain more simply.

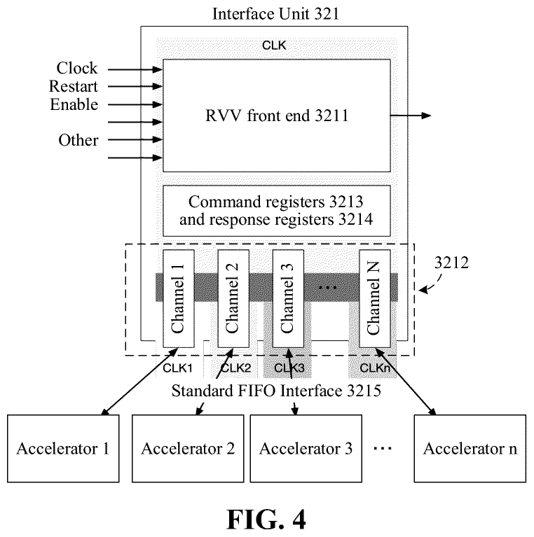

FIG. 5 is a structural block diagram of an exemplary processor 500, according to some embodiments of the present disclosure. As shown in FIG. 5, a processor 500 includes a processor core 510 and a RVV core 520. The processor core 510 can be the scalar core 310 shown in FIG. 3, and the RVV core 520 can be the RVV core 320 shown in FIG. 3.

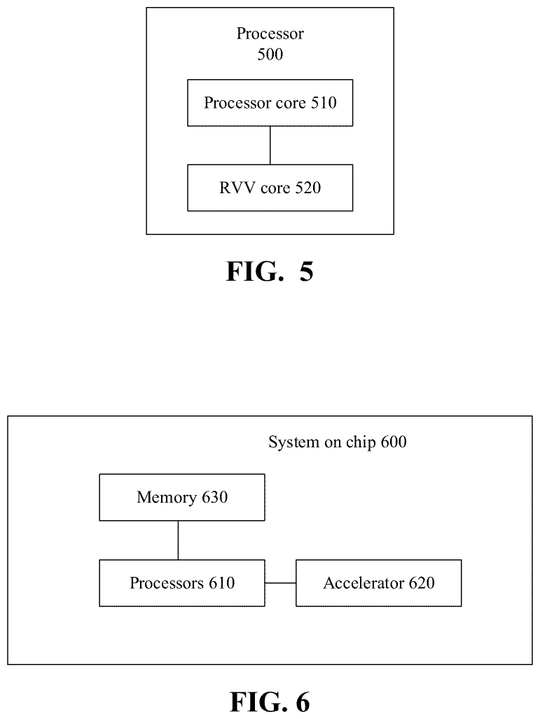

FIG. 6 is a schematic structural diagram of an exemplary system on chip 600, according to some embodiments of the present disclosure. As shown in FIG. 6, a system on chip 600 includes one or more processors 610 and one or more accelerator 620. The processor 610 can be a processor 300 shown in FIG. 3, and the accelerator 620 can be an accelerator 330 shown in FIG. 3. One or more accelerators can be directly connected to one processor. The system on chip 600 further includes a memory 630 communicatively coupled to the one or more processors 610. The memory 630 is configured to store instructions, and the more or more processors 610 are configured to execute the instructions.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A reduced instruction set computer (RISC)-V vector extension (RVV) core directly coupled with one or more accelerators, the RVV core comprising:
a command queue configured to output commands; and
an interface unit communicatively coupled to the command queue and having circuitry configured to generate an accelerator command to an accelerator of the one or more accelerators based on the output commands.

2. The RVV core according to claim 1, wherein the interface unit comprises:
a response register configured to receive instruction set architecture (ISA) of each of the one or more accelerators respectively;
a command register configured to generate the accelerator command based on the ISA of a corresponding accelerator and the command queue; and
an interface configured to communicate with the one or more accelerators.

3. The RVV core according to claim 2, wherein the interface unit further comprises one or more channels, wherein a channel of the one or more channels is each configured to provide a communication channel with a corresponding accelerator.

4. The RVV core according to claim 1, further comprising an RVV register configured to be directly accessible to the one or more accelerators.

5. The RVV core according to claim 4, wherein the RVV register is configured to store data for the RVV core and data for the one or more accelerators.

6. The RVV core according to claim 1, wherein the interface unit is a queue-based first in first out unit.

7. A processor comprising:
a scalar core configured to perform process operations; and
a reduced instruction set computer (RISC)-V vector extension (RVV) core communicated with one or more accelerators, wherein the RVV core comprises:
a command queue configured to output commands; and
an interface unit communicatively coupled to the command queue and having circuitry configured to generate an accelerator command to an accelerator of the one or more accelerators based on the output commands.

8. The processor according to claim 7, wherein the interface unit comprises:
a response register configured to receive instruction set architecture (ISA) of each of the one or more accelerators respectively;
a command register configured to generate the accelerator command based on the ISA of a corresponding accelerator and the command queue; and
an interface configured to communicate with the one or more accelerators.

9. The processor according to claim 8, wherein the interface unit further comprises one or more channels, wherein a channel of the one or more channels is each configured to provide a communication channel with a corresponding accelerator.

10. The processor according to claim 7, wherein the RVV core further an RVV register configured to be directly accessible to the one or more accelerators.

11. The processor according to claim 10, wherein the RVV register is configured to store data for the RVV core and data for the one or more accelerators.

12. A system on chip comprising a processor and one or more accelerators, wherein the processor comprises:
a scalar core configured to execute process operations; and
a reduced instruction set computer (RISC)-V vector extension (RVV) core communicated with the one or more accelerators, and the RVV core comprises:
a command queue configured to output commands; and
an interface unit communicatively coupled to the command queue and having circuitry configured to generate an accelerator command to an accelerator of the one or more accelerators based on the output commands.

13. The system on chip according to claim 12, wherein each of the one or more accelerators comprises an accelerator decoder configured to receive the accelerator command from the RVV core.

14. The system on chip according to claim 12, wherein the RVV core further an RVV register configured to be directly accessible to the one or more accelerators.

15. The system on chip according to claim 14, wherein the RVV register is configured to store data for the RVV core and data for the one or more accelerators.

16. The system on chip according to claim 15, wherein each of the one or more accelerators further comprises:
an accelerator load store unit configured to perform read and write operations on the RVV register of the RVV core.

17. The system on chip according to claim 12, wherein the interface unit comprises:
a response register configured to receive instruction set architecture (ISA) of each of the one or more accelerators respectively;
a command register configured to generate the accelerator command based on the ISA of a corresponding accelerator and the command queue; and
an interface configured to communicate with the one or more accelerators.

18. The system on chip according to claim 17, wherein the interface unit further comprises one or more channels, wherein a channel of the one or more channels is each configured to provide a communication channel with a corresponding accelerator.

19. The system on chip according to claim 12, further comprising a memory communicatively coupled to the scalar core and configured to store instructions for generating and pushing the accelerator commands to the accelerator.

20. The system on chip according to claim 19, wherein the scalar core is further configured to fetch and execute the instructions, and when the instructions are executed, the accelerator commands are generated and pushed to the accelerator.
